(19) United States
(12) Patent Application Publication
(10) Pub. No.: US 2025/0078364 A1
(43) Pub. Date: Mar. 6, 2025

(54) IMAGE GENERATION METHOD AND APPARATUS, COMPUTER-READABLE MEDIUM, AND ELECTRONIC DEVICE

(71) Applicant: DOUYIN VISION CO., LTD., Beijing (CN)

(72) Inventors: Xin LI, Beijing (CN); Peng ZHANG, Beijing (CN); Chaoying CAI, Beijing (CN); Hanyao SHAO, Beijing (CN); Tianxin SHI, Beijing (CN); Feng JIANG, Beijing (CN); Pengxiang YAN, Beijing (CN); Weifeng CHEN, Beijing (CN)

(21) Appl. No.: 18/822,010

(22) Filed: Aug. 30, 2024

(30) Foreign Application Priority Data
Aug. 31, 2023 (CN) 202311116869.8

(51) Int. Cl. G06T 11/60; G06F 3/0482; G06K 7/14

(52) U.S. Cl. CPC G06T 11/60; G06F 3/0482; G06K 7/1417

(57) ABSTRACT

The present disclosure provides an image generation method and apparatus, a computer-readable medium, and an electronic device. The method includes: displaying an image editing interface, a first merchandise image corresponding to a target merchandise is displayed in the image editing interface; determining a target scene to be added to the first merchandise image; and displaying a second merchandise image that is randomly generated by the first merchandise image and the target scene.

### CROSS-REFERENCE TO RELATED APPLICATION

The present application claims priority of the Chinese Patent Application No. 202311116869.8, filed on Aug. 31, 2023, which is incorporated herein by reference in its entirety.

### TECHNICAL FIELD

The present disclosure relates to the technical field of image processing, in particular, to an image generation method and apparatus, a computer-readable medium, and an electronic device.

### BACKGROUND

In the field of e-commerce, a seller, after shelving a merchandise or changing the appearance, function or packaging of the merchandise, needs to upload a merchandise image of the merchandise on an e-commerce platform for customers to browse. However, in the related art, merchandise images are often generated based on manual processing, which makes generation efficiency of the merchandise images low.

### SUMMARY

The summary is provided to introduce concepts in a simplified form, and the concepts are described in more detail below in the detailed description. The summary is not intended to identify key features or essential features of the claimed subject matter, nor is it intended to be used to limit the scope of the claimed subject matter.

In a first aspect, the present disclosure provides an image generation method, and the method includes:
displaying an image editing interface, a first merchandise image corresponding to a target merchandise is displayed in the image editing interface;
determining a target scene to be added to the first merchandise image; and
displaying a second merchandise image that is randomly generated by the first merchandise image and the target scene.

In a second aspect, the present disclosure provides an image generation method, and the method includes:
enabling an image capturing function in response to performing a scanning operation on a target QR code; and
capturing a target merchandise to obtain an original merchandise image, and uploading the original merchandise image to an image editing interface to determine, in response to performing a scene addition operation on a first merchandise image, a target scene corresponding to the scene addition operation in the image editing interface, and to display a second merchandise image that is randomly generated according to the first merchandise image and the target scene, the first merchandise image is obtained based on the original merchandise image.

In a third aspect, the present disclosure provides an image generation apparatus, which includes:
a first display module, configured to display an image editing interface, a first merchandise image corresponding to a target merchandise is displayed in the image editing interface;
a first determining module, configured to determine a target scene to be added to the first merchandise image; and
a second display module, configured to display a second merchandise image that is randomly generated by the first merchandise image and the target scene.

In a fourth aspect, the present disclosure provides an image generation apparatus, which includes:
an enabling module, configured to enable an image capturing function in response to performing a scanning operation on a target QR code; and
a transmission module, configured to capture a target merchandise to obtain an original merchandise image, and upload the original merchandise image to an image editing interface to determine, in response to performing a scene addition operation on a first merchandise image, a target scene corresponding to the scene addition operation in the image editing interface, and to display a second merchandise image that is randomly generated according to the first merchandise image and the target scene, the first merchandise image is obtained based on the original merchandise image.

In a fifth aspect, the present disclosure provides a computer-readable medium, on which computer programs are stored, and the computer programs, when executed by a processing apparatus, implement the steps of the method according to any one of the first aspect or the second aspect.

In a sixth aspect, the present disclosure provides an electronic device, which includes:
a storage apparatus, on which computer programs are stored; and
a processing apparatus, configured to execute the computer programs in the storage apparatus to implement the steps of the method according to any one of the first aspect or the second aspect.

With the above technical solution, after the target scene is determined, the second merchandise image conforming to the target scene can be automatically generated according to the target scene and the first merchandise image. The solution provided by the present disclosure can reduce the difficulty of generating the merchandise images and improve the efficiency of generating the merchandise image compared to the generation of the merchandise images based on the manual processing in the related art. In addition, since the second merchandise image is an image randomly generated according to the first merchandise image and the target scene, upon generating merchandise images for the same image and the same scene, the merchandise image generated each time can be prevented from being repeated, thereby increasing the richness of the merchandise images.

Other features and advantages of the present disclosure are described in detail in the following detailed description.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale. In the drawings:

FIG. 1 is a flowchart illustrating an image generation method according to an exemplary embodiment of the present disclosure;

FIG. 2 is a schematic diagram illustrating a configuration of target scene according to an exemplary embodiment of the present disclosure;

FIG. 3 is a schematic diagram illustrating a generation of a second merchandise image according to a configured target scene according to an exemplary embodiment of the present disclosure;

FIG. 4 is a schematic diagram illustrating another configuration of target scene according to an exemplary embodiment of the present disclosure;

FIG. 5 is a schematic diagram illustrating another generation of a second merchandise image according to a configured target scene according to an exemplary embodiment of the present disclosure;

FIG. 6 is a schematic diagram illustrating yet another configuration of target scene according to an exemplary embodiment of the present disclosure;

FIG. 7 is a schematic diagram illustrating yet another generation of a second merchandise image according to a configured target scene according to an exemplary embodiment of the present disclosure;

FIG. 8 is a schematic diagram illustrating a configuration of target frame according to an exemplary embodiment of the present disclosure;

FIG. 9 is a schematic diagram illustrating a generation of a second merchandise image according to a configured target frame according to an exemplary embodiment of the present disclosure;

FIG. 10 is a flowchart illustrating another image generation method according to an exemplary embodiment of the present disclosure;

FIG. 11 is a block diagram illustrating a structure of an image generation apparatus according to an exemplary embodiment of the present disclosure;

FIG. 12 is a structural block diagram illustrating another image generation apparatus according to an exemplary embodiment of the present disclosure; and

FIG. 13 is a structural schematic diagram illustrating an electronic device according to an exemplary embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and its variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information in interaction between a plurality of apparatuses in this embodiment of present disclosure are for illustrative purposes only and are not intended to limit the scope of such messages or information.

It is to be understood that before using the technical solutions disclosed in each embodiment of the present disclosure, it is needed to inform the type, scope of use, and use scenes, etc. of the personal information involved in the present disclosure to a user and gain the authorization of the user through appropriate methods in accordance with relevant laws and regulations.

For example, when transmitting prompt information to the user in response to an active request of the user so as to clearly prompt the user, the operation requested to be executed needs to gain and use the personal information of the user. Therefore, the user can autonomously select whether to provide personal information for software or hardware such as an electronic device, an application, a server or a storage medium executing the operation of the technical solution of the present disclosure according to the prompt information.

As an optional but non-limited implementation mode, the mode of transmitting the prompt information to the user in response to receiving the active request of the user can be a popup window mode, and the prompt information can be presented in a character mode in the popup window. In addition, the popup window can also carry a selection control for the user to select “Agree” or “Disagree” to provide personal information for the electronic device.

It is to be understood that the above-mentioned processing of informing and gaining the authorization of the user is only indicative and do not limit the implementation mode of the present disclosure, and other modes that meet the relevant laws and regulations can also be applied to the implementation mode of the present disclosure.

Meanwhile, it is to be understood that data involved in this technical solution (including but not limited to the data itself, acquisition or use of data) shall comply with the requirements of relevant laws and regulations and relevant provisions.

As stated in the background art, in the field of e-commerce, a seller, after shelving a merchandise or changing the appearance, function or packaging of the merchandise, needs to upload a merchandise image of the merchandise on an e-commerce platform for customers to browse. However, in the related art, merchandise images are often generated based on manual processing, resulting in low generation efficiency of the merchandise images.

Specifically, generating a merchandise image based on the manual processing, generally includes the following stages:
capturing stage: capturing the merchandise to obtain an initial image;
optimization stage: performing a series of processes on the initial image, such as matting, adding watermarks, adding logo, adding promotional information, and the like.

In order to guarantee the quality of the merchandise image and improve the richness of the merchandise image, in the capturing stage, the merchandise is captured under different scenes by using professional capturing equipment; in the optimization stage, the initial image is subjected to an optimization process by a professional. As a result, not only the generation period of the merchandise image but also the generation cost of the merchandise image is increased.

In view of this, embodiments of the present disclosure provide an image generation method and apparatus, a computer-readable medium, and an electronic device, to solve the above technical problems.

Embodiments of the present disclosure are further explained below with reference to the drawings.

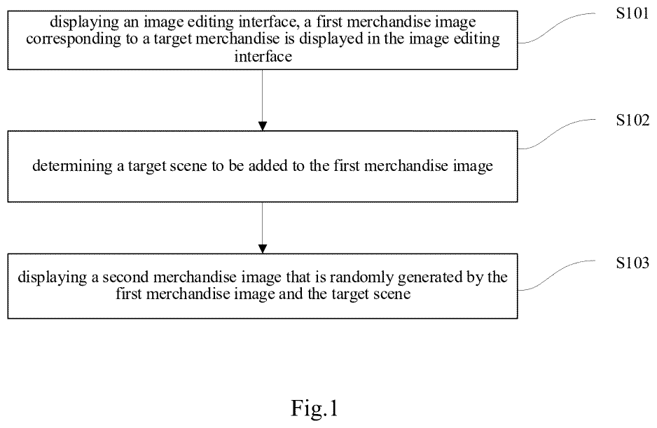

FIG. 1 is a flowchart illustrating an image generation method according to an exemplary embodiment of the present disclosure, and with reference to FIG. 1, the method may include the following steps:

S101: displaying an image editing interface, a first merchandise image corresponding to a target merchandise is displayed in the image editing interface.

The target merchandise is determined according to the actual business scene, which is not limited by the embodiments of the present disclosure. In a possible implementation, the target merchandise can be an electronic product, an apparel, a jewelry, or a cosmetic product, and the like.

In addition, in order to avoid, when subsequently generating the second merchandise image based on the first merchandise image and the target scene, the presence of other interfering objects other than the target merchandise and the target scene in the generated second merchandise image, the first merchandise image may be an image with only the target merchandise.

S102: determining a target scene to be added to the first merchandise image.

The target scene may be obtained by performing a triggering operation on a scene addition control in the image editing interface, may be also obtained by performing a configuration operation on scene information in the image editing interface, and may be obtained by performing a selecting operation on a preset scene or a preset scene material in the image editing interface, which are not limited by the embodiments of the present disclosure.

When the target scene can be obtained by performing the triggering operation on the scene addition control in the image editing interface, the scene addition control can be previously displayed in the image editing interface by triggering the scene addition control to externally import the target scene.

When the target scene can be obtained by performing the configuration operation on the scene information in the image editing interface, a scene information configuration box can be displayed in advance in the image editing interface, and the target scene may be obtained by configuring the scene information in the scene information configuration box. The scene information may include scene elements, relative positions between the scene elements, and scene ambience, etc., which are not limited by the embodiments of the present disclosure.

When the target scene can be obtained by performing the selection operation on the preset scene in the image editing interface, a plurality of preset scene templates can be displayed in advance in the image editing interface, and the target scene is obtained by selecting one of the scene templates.

That is, according to one embodiment of the present disclosure, at least one scene template is displayed in the image editing interface, and determining the target scene to be added to the first merchandise image may include:
determining, in response to a first selection operation in the at least one scene template, a target scene template corresponding to the first selection operation, and determining a target scene according to the target scene template.

The first selection operation on the target scene template may be performing, on the target scene template, a drag operation, a click operation, or a long press operation, etc., which are not limited by the embodiments of the present disclosure.

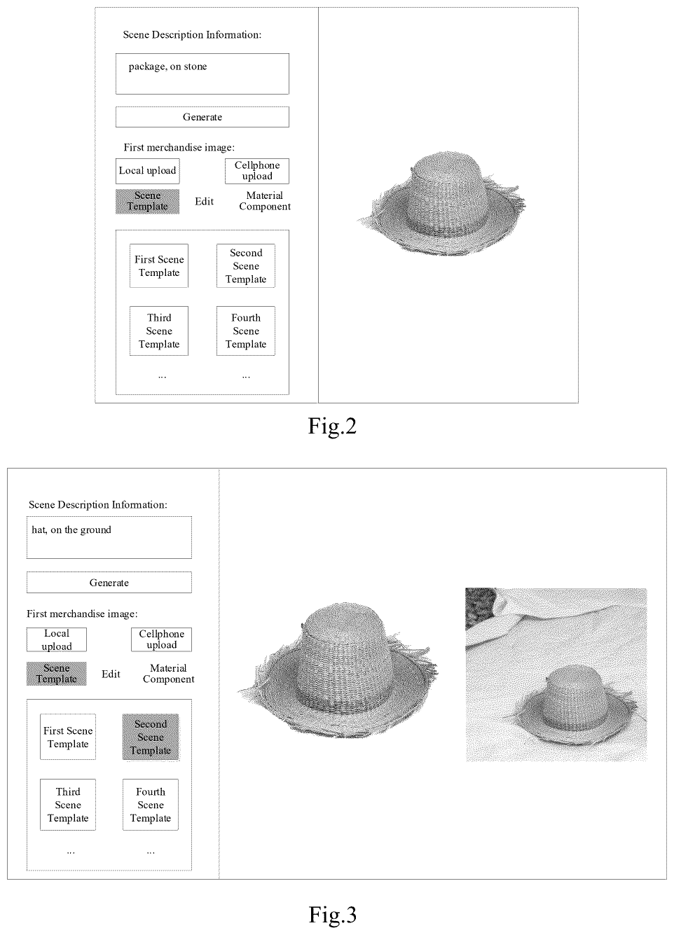

For example, as shown in FIG. 2, a scene template control, i.e., “Scene Template”, is displayed in the image editing interface; by clicking or long pressing the “Scene Template”, a plurality of preset scene templates are displayed in a region below the “Scene Template”, and by clicking on one of the scene templates, e.g., the second scene template, the target scene template is obtained.

It should be noted that the scene template in FIG. 2 should correspond to a specific scene diagram, and it is replaced by text in order to simplify the process in the present embodiment.

In the present embodiment, by displaying at least one scene template in the image editing interface, on the one hand, the general content of the corresponding scene can be intuitively reflected on the basis of the scene template, thereby facilitating the user to select the target scene according to actual requirements. On the other hand, a target scene can be determined by selecting a target scene template, compared with the related art, in which a merchandise image including the target scene is obtained by capturing merchandises in different scenes, the present embodiment provides a solution that effectively reduces the cost of generating the merchandise image and improves the efficiency of generating the merchandise image.

In a possible implementation, determining the target scene according to the target scene template may include:
determining a scene corresponding to the target scene template as the target scene; or
determining, when scene description information corresponding to the target scene template is displayed in the image editing interface, target description information corresponding to an editing operation in response to performing the editing operation on the scene description information, and determining a scene corresponding to the target description information as the target scene.

For example, the user may display “package, on beach” in a scene description information input box after selecting the target scene template. By changing the scene description information in the scene description information input box, for example, changing “on beach” to “on stone”, the resulting target description information is “package, on stone”, and the scene “package placed on stone” corresponding to “package, on stone” is determined as the target scene.

For changing the scene description information in the scene description information input box, the scene description information may be changed in the scene description information input box, or by triggering the scene description information to display the scene description information configuration interface, the scene description information is configured or changed in the scene description information configuration interface, which are not limited by the embodiments of the present disclosure.

When the scene description information is changed in the scene description information input box, a blank region in the scene description information input box may be double-clicked to change the scene description information from the display state to the editing state, thereby changing the scene description information.

When the scene description information is changed in the scene description information configuration interface, the scene description information configuration interface may be displayed by double-clicking on any one of participations or any one of scene description elements in the scene description information, so that the scene description information is configured or changed in the scene description information configuration interface.

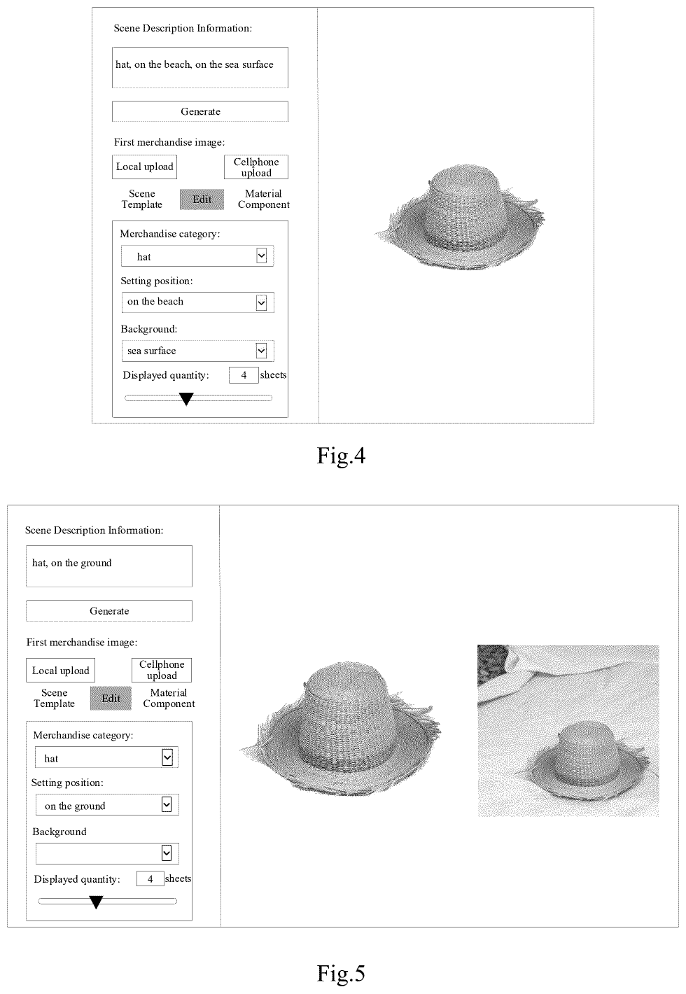

For example, the scene description information configuration interface may be displayed in a lower left region of the image editing interface by double clicking on the scene description elements “hat”, “on the beach”, or “sea surface”, as shown in FIG. 4. The target description information is obtained by clicking on the drop-down menu of each scene description element in the scene description information configuration interface to modify each scene description element, or by directly modifying scene description element in each scene description element input box, as shown in FIG. 5.

It should be understood that double clicking on any one of the participates or any one of the scene description elements in the scene description information and displaying the scene description information configuration interface is merely illustrative and does not constitute a limitation of the solution. In a possible implementation, a scene information editing control can also be displayed on the image editing interface, and the scene description information configuration interface is displayed by triggering the scene information editing control, as shown in FIG. 4, in which “Edit” in FIG. 4 is the scene information editing control.

When the target scene is obtained by a selection operation on the preset scene material in the image editing interface, a plurality of preset scene materials can be displayed in advance in the image editing interface, and the target scene is obtained by selecting one of the scene materials.

That is, according to one embodiment of the present disclosure, at least one scene material is displayed in the image editing interface, and determining the target scene to be added to the first merchandise image may include:
determining, in response to a second selection operation in the at least one scene material, a target scene material corresponding to the second selection operation, and determining a target scene according to the target scene material.

The second selection operation on the target scene material may be a drag operation, a double-click operation or a single-click operation on the target scene material, etc., which is not limited by the embodiments of the present disclosure.

For example, as shown in FIG. 6, a material control, i.e., “Material Component”, is displayed in the image editing interface. By clicking or pressing the “Material Component”, a plurality of preset material components are displayed in a region below the “Material Component”; and by clicking on one of the material components, e.g., the first material component, the target scene is obtained.

In the present embodiment, by displaying at least one material element on the image editing interface, a user can select one or more material elements according to actual needs to build a target scene; compared with the related art, in which a merchandise image including the target scene is obtained by capturing merchandises under different scenes, the present embodiment can effectively reduce the cost of generating the merchandise image and improve the efficiency of generating the merchandise image.

In a possible implementation, in order to further enrich the scene content in the target scene, at least one material component and at least one scene template may also be displayed in the image editing interface, simultaneously, whereby the user may select the target material component and the target scene template from them to custom generate the target scene so that the target scene is more fit with the target merchandise.

S103: displaying a second merchandise image that is randomly generated by the first merchandise image and the target scene.

The second merchandise image may be automatically generated according to the target scene and the first merchandise image after the target scene is determined, or may be manually generated according to the target scene and the first merchandise image after the target scene is determined, which is not limited by the embodiments of the present disclosure.

When the second merchandise image is manually generated according to the target scene and the first merchandise image, a generation control may be displayed on the image editing interface, and the second merchandise image is generated and displayed by triggering the generation control after the target scene is determined.

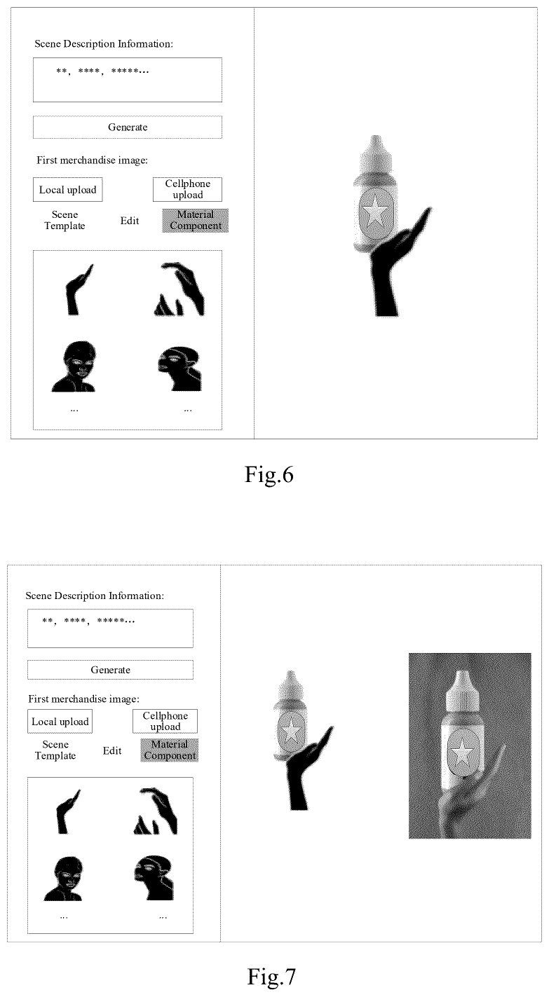

The generation control may be represented by a control identifier, a control name, or a combination of a control name and a control identifier. The triggering operation on the generation control may be a long press operation, a slide operation, or a click operation on the generation control, which is not limited by embodiments of the present disclosure. In a possible implementation, the generation control can be represented by a control name of “Generate”, and after the target scene is determined, the second merchandise image is displayed in a right region of the image editing interface by clicking on the “Generate”, as shown in FIG. 3, FIG. 5, or FIG. 7.

It should be understood that the content shown in the image editing interface is merely illustrative and does not constitute a limitation of the solution. In a possible implementation, after the second merchandise image is generated, the image editing interface may display only the second merchandise image.

With the above technical solution, after the target scene is determined, the second merchandise image conforming to the target scene can be automatically generated according to the target scene and the first merchandise image. The solution provided by the present disclosure can reduce the difficulty of generating the merchandise images and improve the efficiency of generating the merchandise image compared to the generation of the merchandise images based on the manual processing in the related art. In addition, since the second merchandise image is an image randomly generated according to the first merchandise image and the target scene, upon generating merchandise images for the same image and the same scene, the merchandise image generated each time can be prevented from being repeated, thereby increasing the richness of the merchandise images.

In a possible implementation, the method may further include:
displaying, after displaying the second merchandise image, at least one image frame component for describing merchandise information in response to performing a triggering operation on the second merchandise image; and displaying, in response to performing a selection operation on a target frame in the at least one image frame component, the target frame in the second merchandise image.

The merchandise information may be information for describing the attributes of the merchandise, such as the price of the merchandise, the place of origin of the merchandise, or the material of the merchandise, etc.; the merchandise information may also be information for describing the sales situation of the merchandise, such as the favorite ratio of the merchandise, the offer information of the merchandise, or the sales amount of the merchandise, etc., which may be determined according to actual application situations, and are not limited by the embodiments of the present disclosure.

It should be understood that displaying the target frame in the second merchandise image may be that the target frame is displayed in the second merchandise image after selecting the target frame, and may also be that the target frame may be displayed in the second merchandise image by triggering a preset control after selecting the target frame, which are not limited by embodiments of the present disclosure.

In addition, it should be understood that the triggering operation on the second merchandise image may be a single click operation, a long press operation, or a double click operation, etc. on the second merchandise image. The selection operation on the target frame may be a drag operation or a click operation or the like on the target frame, which are not limited by the embodiments of the present disclosure.

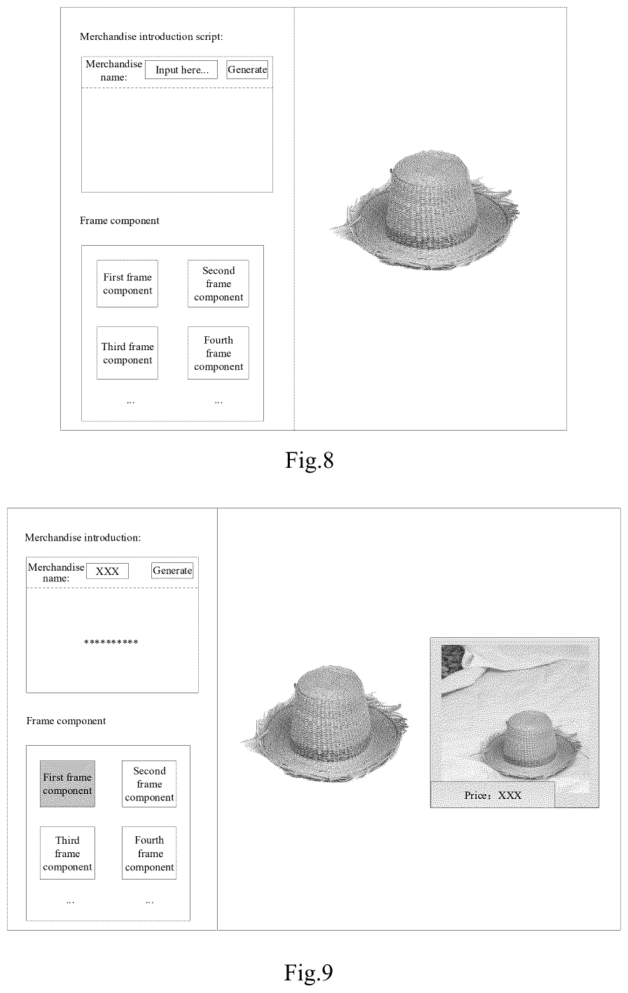

Exemplarily, a plurality of preset image frame components may be displayed in the lower left region of the image editing interface by double-clicking the second merchandise image, and the first image frame is displayed in the frame position of the second merchandise image by clicking the first image frame component, as shown in FIG. 8 and FIG. 9.

It should be noted that the frame component in FIG. 8 or FIG. 9 corresponds to a specific frame component schematic, and it is replaced by text in order to simplify the process in the present embodiment.

In the present embodiment, by displaying at least one image frame element for describing the merchandise information on the image editing interface and adding a corresponding image frame element to the second merchandise image by selecting one of the image frame elements, it is possible to quickly understand the target merchandise according to the merchandise information in the image frame element. Compared with the related art, which requires a professional to perform post P-map processing on an initial image to obtain an image frame element for describing merchandise information, the solution of the present embodiment can effectively reduce the cost of generating merchandise images and improve the efficiency of generating merchandise images.

In a possible implementation, the method may further include:
changing, after displaying the target frame in the second merchandise image, the target frame from a display state to an editing state in response to performing a triggering operation on the target frame; and
changing merchandise information and/or a display manner of the target frame in the second merchandise image in response to performing an editing operation on the target frame in the editing state.

The triggering operation on the target frame may be a long press operation or a double click operation on the target frame, or the like. The editing operation on the target frame may be changing the merchandise information in the target frame, for example, changing the display content, display font, display color, or the like of the merchandise information; changes may also be made to the target frame, for example, changing the display color, display position, or display color of the target frame, which are not limited by the present embodiments.

In the present embodiment, by changing the target frame from the display state to the editing state upon triggering the target frame, the merchandise information and/or the display mode of the target frame can be adaptively changed according to the actual situation, on the one hand, the merchandise information or the display mode can be made to more fit the target merchandise, and on the other hand, occlusion of the target merchandise by the target frame can be avoided.

In a possible implementation, the method may further include:
displaying, after displaying the second merchandise image, an information input control and a script generation control in response to performing a triggering operation on the second merchandise image;
determining, in response to performing an input operation in the information input control, target merchandise information corresponding to the input operation for the target merchandise; and
displaying, in response to performing a triggering operation on the script generation control, target script information for the target merchandise, the target script information is obtained based on the target merchandise information, and the target script information includes more content than the target merchandise information.

The target merchandise information may be a merchandise name or a merchandise category, etc., which is not limited by embodiments of the present disclosure. In a possible implementation, the target merchandise information may be a hair curler, a wool coat, or a chair that can be raised and lowered, or the like.

It should be understood that the display information input control may be a text input box or a drop-down control, which is not limited by embodiments of the present disclosure. When the display information input control is a text input box, the merchandise information can be obtained by inputting text information in the text input box. When the display information input control is a drop-down control, the drop-down control may be triggered to display a list of merchandise categories, and the merchandise information is obtained by selecting a target merchandise category in the list of merchandise categories. For example, by clicking on the drop-down control, a list of merchandise categories is displayed, and the list of merchandise categories is displayed with a mobile phone, a pack, a shirt, a dress, a display, a high-heeled shoe, and a computer, etc.; and by clicking on the pack, merchandise information is obtained.

In addition, it should be understood that the script generation control may be represented by a control identifier, by a control name, or by a combination of a control name and a control identifier. The triggering operation on the script generation control may be a long press operation or a click operation on the script generation control, etc., which is not limited by the embodiments of the present disclosure.

In a possible implementation, the display information input control is a text input box, the script generation control is represented by a control name “Generate”, and the target script information is generated and displayed by inputting the merchandise information in the text input box corresponding to the merchandise name, and by clicking on the “Generate”, as shown in FIGS. 8 and 9.

Compared with the related art, in which a professional is required to write an operation script or a merchandise introduction script corresponding to the target merchandise, the solution provided by the present embodiment can automatically generate the operation script or the merchandise introduction script of a target merchandise after inputting the information of the target merchandise, thereby improving the efficiency of the script generation while reducing the cost.

In a possible implementation, the method may further include:
determining, in response to performing a configuration operation on a displayed quantity, a target quantity corresponding to the configuration operation; and
displaying the second merchandise image that is randomly generated by the first merchandise image and the target scene, includes:
displaying a plurality of second merchandise images with different target quantities, each of the plurality of second merchandise images is randomly generated by the first merchandise image and the target scene.

The configuration operation for the displayed quantity may be manually inputting the displayed quantity, or configuring the displayed quantity by triggering a control, which is not limited by the embodiments of the present disclosure. For example, as shown in FIG. 5, in the scene description information configuration interface, a display quantity input box and a display quantity configuration control are displayed, and the target quantity is obtained by inputting the display quantity in the display quantity input box or by sliding a slide in the display quantity configuration control left and right, i.e., a black triangle in the drawing.

In the present embodiment, by configuring the displayed quantity, the corresponding quantity of second merchandise images can be simultaneously generated according to the target scene and the first target merchandise image after the target scene is determined, whereby the batch generation of merchandise images can be performed when the same target scene is added for the same target merchandise. As compared with the related art, the original image needs to be processed to a different degree to obtain a plurality of merchandise images, and the solution provided by the present embodiment can effectively improve the image generation efficiency. In addition, since the corresponding quantity of second merchandise images are randomly generated according to the first merchandise image and the target scene, it is possible to make the generated plurality of merchandise images not identical, thereby increasing the richness of the merchandise images.

The generated plurality of merchandise images being not identical may refer to that scene description information of each second merchandise image is consistent, but scene details are different. For example, the displayed quantity is set to 3, the scene description information of the target scene is: the handbag is placed on the beach by the sea. Then the generated second merchandise image A may be a handbag placed on the beach of a sea A with a sailboat on the sea surface; the generated second merchandise image B may be a handbag placed on the beach of the sea A with sunset and sunset glow on the sea surface; the generated second merchandise image C may be a handbag placed on the beach of a sea B with sunset glow on the sea surface and a swimming crowd.

In a possible implementation, a plurality of first merchandise images are displayed in the image editing interface, displaying the second merchandise image that is randomly generated by the first merchandise image and the target scene may include:
displaying, for each of the plurality of first merchandise images, a corresponding second merchandise image, each of a plurality of second merchandise images is randomly generated by a corresponding first merchandise image and the target scene.

It should be understood that the merchandises corresponding to the plurality of first merchandise images may be the same or may be different, which are not limited by embodiments of the present disclosure. In a possible implementation, the merchandises to which the plurality of first merchandise images correspond are the same, and the plurality of first merchandise images may be images of a merchandise taken from different angles.

In the present embodiment, by displaying the plurality of first merchandise images in the image editing interface and simultaneously generating, after the target scene is determined, the plurality of second merchandise images according to the plurality of first merchandise images and the target scene. It is thus possible to perform batch generation when adding the same target scene for different merchandises or different views of a same merchandise, thereby improving the image generation efficiency.

In a possible implementation, the method may further include:
displaying an original merchandise image for the target merchandise in response to performing an image addition operation in the image editing interface, the original merchandise image includes other display content except the target merchandise; and
displaying the first merchandise image in the image editing interface in response to performing a matting operation on the original merchandise image.

It should be understood that the image addition operation may be a triggering operation on an image addition control or an image capturing control in the image editing interface, may also be a scanning operation on a Quick Response (QR) code in the image editing interface, and may also be a triggering operation on a link in the image editing interface, which are not limited by the embodiments of the present disclosure.

When the image addition operation is a trigger operation for an image addition control in the image editing interface, the image addition control may be previously displayed in the image editing interface, and the original merchandise image is imported by triggering the image addition control.

When the image addition operation is a triggering operation on an image capturing control in the image editing interface, the image capturing control may be displayed in the image editing interface in advance, an image capturing function is turned on by triggering the image capturing control, and a target merchandise is captured by using the image capturing function to obtain the original merchandise image.

When the image addition operation is a scanning operation on a QR code in the image editing interface or a triggering operation on a link in the image editing interface, the QR code or the link may be displayed in the image editing interface in advance, the QR code may be scanned or the link may be triggered by a first target terminal device with the original merchandise image or a second target terminal device with a capturing function, to turn on an image transfer function of the first target terminal device or the second target terminal device, so that the original merchandise image in the first target terminal device may be uploaded to the image editing interface, or the original merchandise image captured by the second target terminal device may be uploaded to the image editing interface.

It should be further understood that the matting operation on the original merchandise image may be a manual matting of the original merchandise image or an automatic matting of the original merchandise image, which is not limited by the embodiments of the present disclosure. In a possible implementation, to improve image generation efficiency and reduce user's operational complexity and user's learning cost, the image editing interface may be displayed with a matting control, and the original merchandise image is automatically matted by triggering the matting control, to obtain the first merchandise image.

In the present embodiment, the uploaded original merchandise image may be matted in the image editing interface such that only the target merchandise is contained in the first merchandise image. On the other hand, since the image editing interface has a built-in matting function, users do not need additionally learn to use other application software for the matting processing, and there is no need to perform switching of the application software during the image generation processing, thereby simplifying the operational complexity of the image generation processing, and improving the image generation efficiency.

In a possible implementation, the method may further include:
displaying a target QR code in response to performing a triggering operation on an image uploading control in the image editing interface, the target QR code is used for uploading an image to the image editing interface through a terminal device with an image capturing function; and
displaying the first merchandise image, the first merchandise image is obtained based on an original merchandise image, and the original merchandise image is captured by the terminal device after scanning the target QR code and uploaded to the image editing interface.

It should be understood that the image uploading control may be represented by a control identifier, a control name, or a combination of a control name and a control identifier. The triggering operation on the image uploading control may be a long press operation, a slide operation, or a click operation, etc. on the image uploading control, which is not limited by the embodiments of the present disclosure. In a possible implementation, the image uploading control can be represented by the control name “Cellphone upload” and the target QR code is displayed by clicking on “Cellphone upload”.

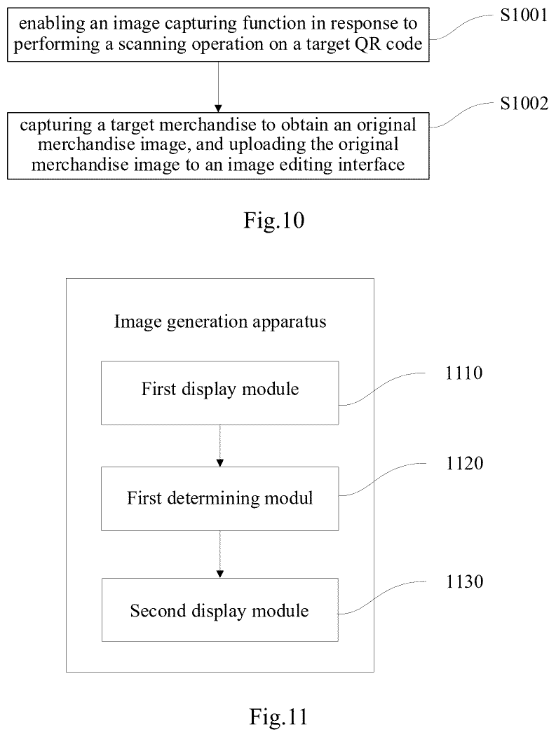

Based on the same technical concept, embodiments of the present disclosure further provide an image generation method, as shown in FIG. 10, the method may include:

S1001: enabling an image capturing function in response to performing a scanning operation on a target QR code.

In a possible implementation, in order to make the captured image clearer or more standardized and facilitate subsequent image processing, after enabling the image capturing function, an image capturing interface may be displayed and at least one object capturing contour may be displayed on the image capturing interface; by selecting one of the object capturing contours, the rest of the object capturing contours except the selected object capturing contour may be hidden, so that a user may be guided to capture the target merchandise according to the selected object capturing contour, that is, the user, when capturing the target merchandise, may be guided to place the target merchandise in the object contour or in conformity with the object contour by adjusting the relative position between the target merchandise and the image capturing interface, which results in a clearer or more standardized original merchandise image.

S1002: capturing a target merchandise to obtain an original merchandise image, and uploading the original merchandise image to an image editing interface to determine, in response to performing a scene addition operation on a first merchandise image, a target scene corresponding to the scene addition operation in the image editing interface, and to display a second merchandise image that is randomly generated according to the first merchandise image and the target scene, the first merchandise image is obtained based on the original merchandise image.

Based on the same technical concept, embodiments of the present disclosure further provide an image generation apparatus, as shown in FIG. 11, which may include:
a first display module 1110, configured to display an image editing interface, a first merchandise image corresponding to a target merchandise is displayed in the image editing interface;
a first determining module 1120, configured to determine a target scene to be added to the first merchandise image; and
a second display module 1130, configured to display a second merchandise image that is randomly generated by the first merchandise image and the target scene.

In a possible implementation, at least one scene template is displayed in the image editing interface, and accordingly, the first determining module 1120 may include:
a first determining unit, configured to determine, in response to a first selection operation in the at least one scene template, a target scene template corresponding to the first selection operation, and determine a target scene according to the target scene template.

In a possible implementation, the first determining unit may include:
a first determining subunit, configured to determine a scene corresponding to the target scene template as the target scene; or
a second determining subunit, configured to determine, when scene description information corresponding to the target scene template is displayed in the image editing interface, target description information corresponding to an editing operation in response to performing the editing operation on the scene description information, and determine a scene corresponding to the target description information as the target scene.

In a possible implementation, at least one scene material is displayed in the image editing interface, and accordingly, the first determining module 1120 may include:
a second determining unit, configured to determine, in response to a second selection operation in the at least one scene material, a target scene material corresponding to the second selection operation, and determine a target scene according to the target scene material.

In a possible implementation, the image generation apparatus may further include:
a third display module, configured to display, after displaying the second merchandise image, at least one image frame component for describing merchandise information in response to performing a triggering operation on the second merchandise image; and
a fourth display module, configured to display, in response to performing a selection operation on a target frame in the at least one image frame component, the target frame in the second merchandise image.

In a possible implementation, the image generation apparatus may further include:
a state changing module, configured to change, after displaying the target frame in the second merchandise image, the target frame from a display state to an editing state in response to performing a triggering operation on the target frame; and
an information changing module, configured to change merchandise information and/or a display manner of the target frame in the second merchandise image in response to performing an editing operation on the target frame in the editing state.

In a possible implementation, the image generation apparatus may further include:
a fifth display module, configured to display, after displaying the second merchandise image, an information input control and a script generation control in response to performing a triggering operation on the second merchandise image;
a second determining module, configured to determine, in response to performing an input operation in the information input control, target merchandise information corresponding to the input operation for the target merchandise; and
a sixth display module, configured to display, in response to performing a triggering operation on the script generation control, target script information for the target merchandise, the target script information is obtained based on the target merchandise information, and the target script information includes more content than the target merchandise information.

In a possible implementation, the image generation apparatus may further include:
a third determining module, configured to determine, in response to performing a configuration operation on a displayed quantity, a target quantity corresponding to the configuration operation; and
accordingly, the first display module may be configured to display a plurality of second merchandise images with different target quantities, each of the plurality of second merchandise images is randomly generated by the first merchandise image and the target scene.

In a possible implementation, a plurality of first merchandise images are displayed in the image editing interface, and accordingly, the first display module may be configured to display, for each of the plurality of first merchandise images, a corresponding second merchandise image, each of a plurality of second merchandise images is randomly generated by a corresponding first merchandise image and the target scene.

In a possible implementation, the image generation apparatus may further include:
a seventh display module, configured to display an original merchandise image for the target merchandise in response to performing an image addition operation in the image editing interface, the original merchandise image includes other display content except the target merchandise; and
an eighth display module, configured to display the first merchandise image in the image editing interface in response to performing a matting operation on the original merchandise image.

In a possible implementation, the image generation apparatus may further include:
a ninth display module, configured to display a target QR code in response to performing a triggering operation on an image uploading control in the image editing interface, the target QR code is used for uploading an image to the image editing interface through a terminal device with an image capturing function; and
a tenth display module, configured to display the first merchandise image, the first merchandise image is obtained based on an original merchandise image, and the original merchandise image is captured by the terminal device after scanning the target QR code and uploaded to the image editing interface.

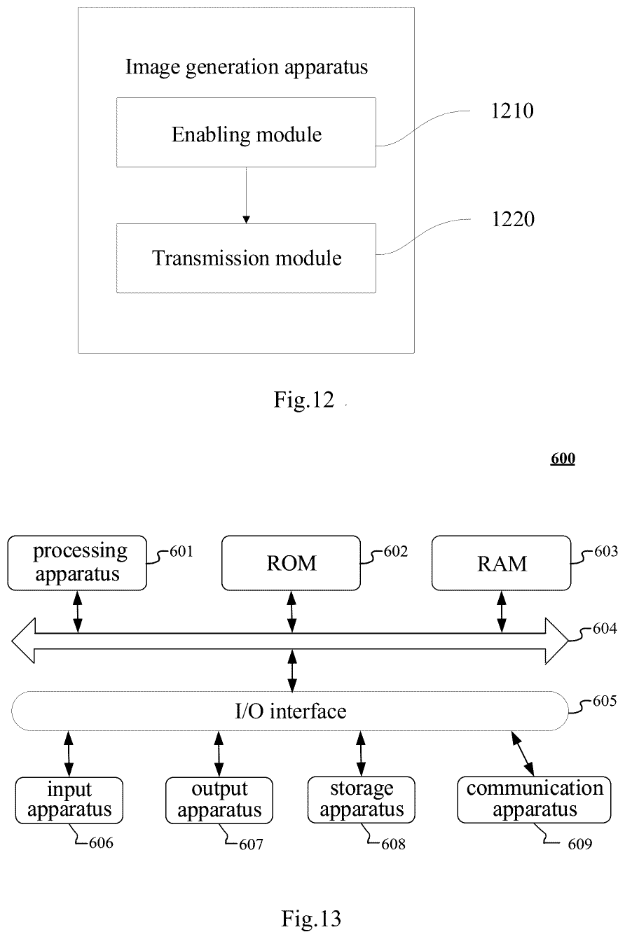

Based on the same technical concept, embodiments of the present disclosure further provide an image generation apparatus, as shown in FIG. 12, which may include:
an enabling module 1210, configured to enable an image capturing function in response to performing a scanning operation on a target QR code; and
a transmission module 1220, configured to capture a target merchandise to obtain an original merchandise image, and upload the original merchandise image to an image editing interface to determine, in response to performing a scene addition operation on a first merchandise image, a target scene corresponding to the scene addition operation in the image editing interface, and to display a second merchandise image that is randomly generated according to the first merchandise image and the target scene, the first merchandise image is obtained based on the original merchandise image.

Based on the same technical concept, embodiments of the present disclosure further provide a computer-readable medium, and the computer programs, when executed by a processing apparatus, implement the steps of the method of any one of the above-mentioned method.

Based on the same technical concept, embodiments of the present disclosure further provide an electronic device, which includes:
a storage apparatus, on which computer programs are stored; and
a processing apparatus, configured to execute the computer programs in the storage apparatus to implement the steps of the method according to any one of the above-mentioned method.

Referring to FIG. 13, FIG. 13 illustrates a schematic structural diagram of an electronic device 600 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 13 is merely an example, and should not pose any limitation to the functions and the range of use of the embodiments of the present disclosure.

As shown in FIG. 13, the electronic device 600 may include a processing apparatus 601 (e.g., a central processing unit, a graphics processing unit, etc.), which can perform various suitable actions and processing according to a program stored in a read-only memory (ROM) 602 or a program loaded from a storage apparatus 608 into a random-access memory (RAM) 603. The RAM 603 further stores various programs and data required for operations of the electronic device 600. The processing apparatus 601, the ROM 602, and the RAM 603 are interconnected by means of a bus 604. An input/output (I/O) interface 605 is also connected to the bus 604.

Usually, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 13 illustrates the electronic device 600 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: display an image editing interface, a first merchandise image corresponding to a target merchandise is displayed in the image editing interface; determine a target scene to be added to the first merchandise image; and display a second merchandise image that is randomly generated by the first merchandise image and the target scene.

Alternatively, the above-mentioned computer-readable medium carries one or more programs, and when the one or more programs are executed by the electronic device, the electronic device is caused to: enable an image capturing function in response to performing a scanning operation on a target QR code; and capture a target merchandise to obtain an original merchandise image, and upload the original merchandise image to an image editing interface to determine, in response to performing a scene addition operation on a first merchandise image, a target scene corresponding to the scene addition operation in the image editing interface, and to display a second merchandise image that is randomly generated according to the first merchandise image and the target scene, the first merchandise image is obtained based on the original merchandise image.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. An image generation method, comprising:
displaying an image editing interface, wherein a first merchandise image corresponding to a target merchandise is displayed in the image editing interface;
determining a target scene to be added to the first merchandise image; and
displaying a second merchandise image that is randomly generated by the first merchandise image and the target scene.

2. The method according to claim 1, wherein at least one scene template is displayed in the image editing interface, and determining the target scene to be added to the first merchandise image comprises:
determining, in response to a first selection operation in the at least one scene template, a target scene template corresponding to the first selection operation, and determining a target scene according to the target scene template.

3. The method according to claim 2, wherein determining the target scene according to the target scene template comprises:
determining a scene corresponding to the target scene template as the target scene; or
determining, when scene description information corresponding to the target scene template is displayed in the image editing interface, target description information corresponding to an editing operation in response to performing the editing operation on the scene description information, and determining a scene corresponding to the target description information as the target scene.

4. The method according to claim 1, wherein at least one scene material is displayed in the image editing interface, and determining the target scene to be added to the first merchandise image comprises:
determining, in response to a second selection operation in the at least one scene material, a target scene material corresponding to the second selection operation, and determining a target scene according to the target scene material.

5. The method according to claim 1, further comprising:
displaying, after displaying the second merchandise image, at least one image frame component for describing merchandise information in response to performing a triggering operation on the second merchandise image; and
displaying, in response to performing a selection operation on a target frame in the at least one image frame component, the target frame in the second merchandise image.

6. The method according to claim 2, further comprising:
displaying, after displaying the second merchandise image, at least one image frame component for describing merchandise information in response to performing a triggering operation on the second merchandise image; and
displaying, in response to performing a selection operation on a target frame in the at least one image frame component, the target frame in the second merchandise image.

7. The method according to claim 4, further comprising:
displaying, after displaying the second merchandise image, at least one image frame component for describing merchandise information in response to performing a triggering operation on the second merchandise image; and
displaying, in response to performing a selection operation on a target frame in the at least one image frame component, the target frame in the second merchandise image.

8. The method according to claim 5, further comprising:
changing, after displaying the target frame in the second merchandise image, the target frame from a display state to an editing state in response to performing a triggering operation on the target frame; and
changing merchandise information and/or a display manner of the target frame in the second merchandise image in response to performing an editing operation on the target frame in the editing state.

9. The method according to claim 1, further comprising:
displaying, after displaying the second merchandise image, an information input control and a script generation control in response to performing a triggering operation on the second merchandise image;
determining, in response to performing an input operation in the information input control, target merchandise information corresponding to the input operation for the target merchandise; and
displaying, in response to performing a triggering operation on the script generation control, target script information for the target merchandise, wherein the target script information is obtained based on the target merchandise information, and the target script information comprises more content than the target merchandise information.

10. The method according to claim 2, further comprising:
displaying, after displaying the second merchandise image, an information input control and a script generation control in response to performing a triggering operation on the second merchandise image;
determining, in response to performing an input operation in the information input control, target merchandise information corresponding to the input operation for the target merchandise; and
displaying, in response to performing a triggering operation on the script generation control, target script information for the target merchandise, wherein the target script information is obtained based on the target merchandise information, and the target script information comprises more content than the target merchandise information.

11. The method according to claim 4, further comprising:
displaying, after displaying the second merchandise image, an information input control and a script generation control in response to performing a triggering operation on the second merchandise image;
determining, in response to performing an input operation in the information input control, target merchandise information corresponding to the input operation for the target merchandise; and
displaying, in response to performing a triggering operation on the script generation control, target script information for the target merchandise, wherein the target script information is obtained based on the target merchandise information, and the target script information comprises more content than the target merchandise information.

12. The method according to claim 1, further comprising:
determining, in response to performing a configuration operation on a displayed quantity, a target quantity corresponding to the configuration operation; and
displaying the second merchandise image that is randomly generated by the first merchandise image and the target scene, comprises:
displaying a plurality of second merchandise images with different target quantities, wherein each of the plurality of second merchandise images is randomly generated by the first merchandise image and the target scene.

13. The method according to claim 1, wherein a plurality of first merchandise images are displayed in the image editing interface, displaying the second merchandise image that is randomly generated by the first merchandise image and the target scene, comprises:
displaying, for each of the plurality of first merchandise images, a corresponding second merchandise image, wherein each of a plurality of second merchandise images is randomly generated by a corresponding first merchandise image and the target scene.

14. The method according to claim 1, further comprising:
displaying an original merchandise image for the target merchandise in response to performing an image addition operation in the image editing interface, wherein the original merchandise image comprises other display content except the target merchandise; and
displaying the first merchandise image in the image editing interface in response to performing a matting operation on the original merchandise image.

15. The method according to claim 1, further comprising:
displaying a target QR code in response to performing a triggering operation on an image uploading control in the image editing interface, wherein the target QR code is used for uploading an image to the image editing interface through a terminal device with an image capturing function; and
displaying the first merchandise image, wherein the first merchandise image is obtained based on an original merchandise image, and the original merchandise image is captured by the terminal device after scanning the target QR code and uploaded to the image editing interface.

16. An image generation method, comprising:
enabling an image capturing function in response to performing a scanning operation on a target QR code; and
capturing a target merchandise to obtain an original merchandise image, and uploading the original merchandise image to an image editing interface to determine, in response to performing a scene addition operation on a first merchandise image, a target scene corresponding to the scene addition operation in the image editing interface, and to display a second merchandise image that is randomly generated according to the first merchandise image and the target scene, wherein the first merchandise image is obtained based on the original merchandise image.

17. A computer-readable medium, wherein computer programs are stored on the computer-readable medium, and the computer programs, when executed by a processing apparatus, implement the steps of the method according to claim 1.

18. An electronic device, comprising:
a storage apparatus, on which computer programs are stored; and
a processing apparatus, configured to execute the computer programs in the storage apparatus to implement:
displaying an image editing interface, wherein a first merchandise image corresponding to a target merchandise is displayed in the image editing interface,
determining a target scene to be added to the first merchandise image, and
displaying a second merchandise image that is randomly generated by the first merchandise image and the target scene; or
enabling an image capturing function in response to performing a scanning operation on a target QR code, and
capturing a target merchandise to obtain an original merchandise image, and uploading the original merchandise image to an image editing interface to determine, in response to performing a scene addition operation on a first merchandise image, a target scene corresponding to the scene addition operation in the image editing interface, and to display a second merchandise image that is randomly generated according to the first merchandise image and the target scene, wherein the first merchandise image is obtained based on the original merchandise image.

19. The electronic device according to claim 18, wherein the processing apparatus is further configured to execute the computer programs in the storage apparatus to implement:
displaying, after displaying the second merchandise image, at least one image frame component for describing merchandise information in response to performing a triggering operation on the second merchandise image; and
displaying, in response to performing a selection operation on a target frame in the at least one image frame component, the target frame in the second merchandise image.

20. The electronic device according to claim 18, wherein the processing apparatus is further configured to execute the computer programs in the storage apparatus to implement:
displaying, after displaying the second merchandise image, an information input control and a script generation control in response to performing a triggering operation on the second merchandise image;
determining, in response to performing an input operation in the information input control, target merchandise information corresponding to the input operation for the target merchandise; and
displaying, in response to performing a triggering operation on the script generation control, target script information for the target merchandise, wherein the target script information is obtained based on the target merchandise information, and the target script information comprises more content than the target merchandise information.
